(19) United States
(12) Patent Application Publication
(10) Pub. No.: US 2015/0009086 A1
(43) Pub. Date: Jan. 8, 2015

(54) ACTIVE ANTENNA SYSTEM WITH MULTIPLE FEED PORTS AND CONTROL METHOD THEREOF

(71) Applicant: Ming-Hao Yeh, New Taipei City (TW)

(72) Inventor: Ming-Hao Yeh, New Taipei City (TW)

(21) Appl. No.: 14/312,073

(22) Filed: Jun. 23, 2014

(30) Foreign Application Priority Data
Jul. 2, 2013 (TW) 102123645

(51) Int. Cl. H01Q 1/50

(52) U.S. Cl. CPC H01Q 1/50
USPC 343/858

(57) ABSTRACT

An active antenna system with multiple feed ports and a control method of the active antenna system are provided. The active antenna system includes an antenna radiation element, a first feed port and a second feed port. If the first control circuit is in a close state, the first feed port and a first physical position of the antenna radiation element are connected with each other, so that a signal is fed to the antenna radiation element through the first feed port and the first physical position. If the second control circuit is in the close state, the second feed port and a second physical position of the antenna radiation element are connected with each other, so that the signal is fed to the antenna radiation element through the second feed port and the second physical position.

This application claims the benefit of Taiwan Patent Application No. 102123645, filed Jul. 2, 2013, the subject matter of which is incorporated herein by reference.

### FIELD OF THE INVENTION

The present invention relates to an antenna system and a control method thereof, and more particularly to an active antenna system with multiple feed ports and a control method thereof.

### BACKGROUND OF THE INVENTION

Generally, a single-fed passive antenna is widely used in a wireless consumer product. This type of antenna is simple in structure, easy to use, cost-effective and small-sized. This antenna has only a single feed port and is able to support all frequency bands of the communication system. For example, the antenna is a Bluetooth antenna, a WiFi antenna, a 2G mobile antenna or a 3G mobile antenna. Generally, the frequency bands of the 2G mobile antenna are in the range between 824 MHz and 960 MHz and in the range between 1710 MHz and 1990 MHz. Moreover, the frequency band of the 3G mobile antenna is in the range between 1920 MHz and 2170 MHz (i.e. Band 1) attracts more attention. As a whole, the 2G/3G frequency bands cover a low frequency band (824 MHz˜960 MHz) and a high frequency band (1710 MHz˜2170 MHz).

With increasing development of the current global mobile communication technology, a fourth generation long term evolution (4G LTE) technology becomes more popular. In many areas of the world, the operation frequency band of the 4G mobile communication standard is wider than the 2G/3 G operation frequency band. Especially, the 700 MHz frequency band (Band 13 and Band 17 in USA) and the 2300˜2620 MHz frequency band (Band 38 and Band 40 in China) attract intensive attention.

It is difficult for allowing the 4G mobile antenna to simultaneously support the existing 2G/3G frequency bands and the advanced 4G frequency band. Recently, the integration level of the functions of the mobile phone is gradually increased, and the thickness of mobile phone is gradually decreased. Consequently, the inner space of the mobile phone for accommodating the antenna is gradually restricted. Due to these reasons, it is more difficult to design the 4G mobile antenna.

FIG. 1A schematically illustrates the configurations of a conventional single-fed 4G passive antenna. FIG. 1B schematically illustrates the dimensions of a radiation element of the antenna of FIG. 1A. FIG. 1C schematically illustrates the relationship between the measured return loss and the frequency bandwidth of the antenna of FIG. 1A. The information about this antenna is published in IEEE Transactions on Antennas and Propagation, Vol. 59, NO. 11, November 2011 page 4215-4221 and entitled “Internal Coupled-Fed Dual-loop Antenna Integrated with a USB Connector for WWAN/LTE Mobile Handset”.

As shown in FIG. 1A, the antenna is formed on a printed circuit board (PCB), which is made of FR4 material. The printed circuit board has an overall length of 115 mm and an overall width of 55 mm. A metal ground surface 130 corresponding to the antenna has a length of 105 mm and a width of 55 mm. The width w of an antenna clearance region is 10 mm. The length of the antenna clearance region is equal to the width of the printed circuit board (i.e. 55 mm). A radiation element 120 of the antenna is included in the antenna clearance region.

As shown in FIG. 1B, the point A is the only feed port of the radiation element 120, and the point B is the only ground terminal of the radiation element 120. Moreover, the metal ground surface 130 is formed on the bottom layer of the FR4 printed circuit board. Both of the radiation element 120 and the feed port A are formed on a top layer of the FR4 printed circuit board. The radiation element 120 is directly connected with the metal ground surface 130 at the point B′ through a via.

Generally, a larger width w of the antenna clearance region is beneficial to the antenna design and the antenna property. In views of the product design, the antenna has to be installed within a case of the mobile phone. However, since the width w of the antenna clearance region is larger, the outer appearance of the mobile phone is highly dependent on the antenna clearance region. Especially, the length of the mobile phone is influenced by the larger width w of the antenna clearance region. On the other hand, since the systematic integration of the inner circuitry of the mobile phone is very high, the mobile phone has no enough inner space for accommodating the antenna. Moreover, since the width w of the antenna clearance region is 10 mm, this dimension is too large to design the modern mobile phone.

The result of the measured return loss of FIG. 10 is based on a bandwidth definition of a voltage standing wave ratio (VSWR)=3:1 (i.e. −6 dB return loss). Consequently, the antenna bandwidth covers the frequency band BW_a (700 MHz-1170 MHz) and the frequency band BW_b (1705 MHz-2740 MHz).

However, in designing the antenna of the mobile phone, the integration between the antenna and the circuitry system should be taken into consideration. That is, the matching between the power amplifier (PA) and the low noise amplifier (LNA) of the circuitry system and the antenna is an important factor of designing the antenna. Consequently, the result of the measured return loss is based on the bandwidth definition of VSWR=2:1 (i.e. −10 dB return loss). That is, the standard of the antenna becomes more stringent. Consequently, after the antenna is integrated into the circuitry system, the performance is optimized. According to the bandwidth definition of VSWR=2:1, the antenna bandwidth covers the frequency band BW_c (725 MHz-800 MHz) and the frequency band BW_d (1900 MHz-2700 MHz). In other words, the antenna bandwidth is narrowed. As shown in FIG. 1C, the frequency band BW_c (725 MHz-800 MHz) and the frequency band BW_d (1900 MHz-2700 MHz) cannot cover all 2G/3G/4G frequency bands. In fact, the antenna bandwidth fails to meet the antenna design requirements of the mobile phone.

FIG. 2A schematically illustrates the configurations of another conventional single-fed 4G passive antenna. FIG. 2B schematically illustrates the dimensions of a radiation element of the antenna of FIG. 2A. FIG. 2C schematically illustrates the relationship between the measured return loss and the frequency bandwidth of the antenna of FIG. 2A. The information about this antenna is published in Antennas and Propagation Society Internal Symposium (APSURSI), 2010 IEEE, Conference date 11-17 Jul. 2010 (Toronto) and entitled “Internal Small-size PIFA for LTE/GSM/UMTS Operation in Mobile Phone”.

As shown in FIG. 2A, the antenna is formed on a printed circuit board (PCB), which is made of FR4 material. The printed circuit board has an overall length of 115 mm and an overall width of 45 mm. A metal ground surface 230 corresponding to the antenna has a length of 100 mm and a width of 45 mm. The width w of an antenna clearance region is 15 mm. The length of the antenna clearance region is equal to the width of the printed circuit board (i.e. 45 mm). A radiation element 220 of the antenna is included in the antenna clearance region.

As shown in FIG. 2B, the point A is the only feed port of the radiation element 220, and the point B is the only ground terminal of the radiation element 220. Moreover, the metal ground surface 230 is formed on the bottom layer of the FR4 printed circuit board. Both of the radiation element 220 and the feed port A are formed on a top layer of the FR4 printed circuit board. The radiation element 220 is directly connected with the metal ground surface 230 at the point B through a via. Obviously, since the width w of the antenna clearance region is 15 mm, this dimension is too large to design the modern mobile phone.

The result of the measured return loss of FIG. 2C is based on a bandwidth definition of a voltage standing wave ratio (VSWR)=3:1 (i.e. −6 dB return loss). Consequently, the antenna bandwidth covers the frequency band BW_a (695 MHz-1040 MHz) and the frequency band BW_b (1580 MHz-2840 MHz). Similarly, according to the bandwidth definition of VSWR=2:1, the antenna bandwidth covers four small frequency bands BW_c (700 MHz-775 MHz), BW_d (1750 MHz-1950 MHz), BW_e (2100 MHz-2250 MHz) and BW_f (2650 MHz-2800 MHz). In other words, the antenna bandwidth is narrowed. In fact, the antenna bandwidth still fails to meet the antenna design requirements of the mobile phone.

FIG. 3A schematically illustrates the configurations of another conventional single-fed 4G passive antenna. FIG. 3B schematically illustrates the dimensions of a radiation element of the antenna of FIG. 3A. FIG. 3C schematically illustrates the relationship between the measured return loss and the frequency bandwidth of the antenna of FIG. 3A. The information about this antenna is published in IEEE Transactions on Antennas and Propagation, Vol. 58, NO. 10, October 2010 page 3426-3431 and entitled “Planar Printed Strip Monopole With a Closely-Coupled Parasitic Shorted Strip For Eight-Band LTE/GSM/UMTS Mobile Phone”.

As shown in FIG. 3A, the antenna is formed on a printed circuit board (PCB), which is made of FR4 material. The printed circuit board has an overall length of 119 mm and an overall width of 64 mm. A metal ground surface 330 corresponding to the antenna has a length of 104 mm and a width of 64 mm. The width w of an antenna clearance region is 15 mm. The length of the antenna clearance region is equal to the width of the printed circuit board (i.e. 64 mm). A radiation element 320 of the antenna is included in the antenna clearance region.

As shown in FIG. 3B, the point A is the only feed port of the radiation element 320, and the point B is the only ground terminal of the radiation element 320. Moreover, the metal ground surface 330 is formed on the bottom layer of the FR4 printed circuit board. Both of the radiation element 320 and the feed port A are formed on a top layer of the FR4 printed circuit board. The radiation element 320 is directly connected with the metal ground surface 330 at the point B through a via. Obviously, since the width w of the antenna clearance region is 15 mm, this dimension is too large to design the modern mobile phone.

The result of the measured return loss is shown in FIG. 3C. It is found that the frequency bands of the antenna bandwidth fails to meet the standard of the bandwidth definition of VSWR=2:1.

Since the 4G mobile antenna has to support all of the 2G/3G/4G frequency bands, the 4G mobile antenna designed according to the concept of the single-fed 4G passive antenna has many disadvantages such as large size, poor antenna match or insufficient bandwidth.

For solving the above drawbacks, the concept of designing a single-fed active antenna has been applied to the 4G mobile antenna. Generally, a tunable capacitor module is widely used in an antenna matching circuit.

FIG. 4 is a schematic functional block diagram illustrating a conventional single-fed active antenna system. As shown in FIG. 4, the antenna system comprises a control chip 410, a control interface 420, a high voltage output capacitor controller 430, an antenna feed transmission line 450, a tunable capacitor module 460, and an antenna radiation element 470. The tunable capacitor module 460 is directly installed on the antenna feed transmission line 450 and used as a matching circuit of the antenna radiation element 470. A high voltage output signal 440 is outputted from the high voltage output capacitor controller 430. The magnitude of the high voltage output signal 440 is in the range between 0 and 30V for controlling the capacitance value of the variable capacitor of the tunable capacitor module 460.

When the mobile phone and the base station communicate with each other at a specified operation frequency, the antenna radiation element 470 has to match the specified operation frequency. For matching the specified operation frequency, the capacitance value of the tunable capacitor module 460 is set as a specified capacitance value. Consequently, through the control interface 420, the control chip 410 requests the high voltage output capacitor controller 430 to output the high voltage output signal 440. According to the high voltage output signal 440, the capacitance value of the tunable capacitor module 460 is adjusted to the specified capacitance value.

In the stages of designing the antenna system, various capacitance values of the tunable capacitor module 460 corresponding to plural operations frequencies are defined in advance, and these capacitance values are created as a database and stored in the memory of the mobile phone. In other words, the complexity of designing the antenna is increased.

Generally, the capacitance value of the tunable capacitor module 460 is usually lower than 10 pF. Moreover, the current technology is unable to integrate an inductor into the tunable capacitor module 460. Consequently, after the antenna radiation element 470 matches the tunable capacitor module 460, the dynamic range of the operation frequency of the antenna system is limited. However, by using this designing concept, it is difficult to have the antenna bandwidth cover all of the 2G/3G/4G frequency bands between 700 MHz (minimum) and 2620 MHz (maximum). For achieving the matching purpose, it is a challenge to design the matching circuit of the tunable capacitor module 460.

### SUMMARY OF THE INVENTION

An embodiment of the present invention provides an active antenna system with multiple feed ports. The active antenna system includes a printed circuit board, an antenna radiation element, a metal ground surface, a first control circuit, and a second control circuit. The printed circuit board has an antenna clearance region. The antenna radiation element is included in the antenna clearance region. The antenna radiation element has a first physical position and a second physical position. The metal ground surface is formed on a first layer of the printed circuit board and outside the antenna clearance region. A first terminal of the first control circuit is connected to the first physical position, a second terminal of the first control circuit is connected to a first feed port, and a control terminal of the first control circuit receives a first control signal. The first feed port and the first physical position are selectively connected with each other or disconnected from each other according to the first control signal. A first terminal of the second control circuit is connected to the second physical position, a second terminal of the second control circuit is connected to a second feed port, and a control terminal of the second control circuit receives a second control signal. The second feed port and the second physical position are selectively connected with each other or disconnected from each other according to the second control signal. The first control circuit and the first feed port are formed on a second layer of the printed circuit board and outside the antenna clearance region.

Another embodiment of the present invention provides an active antenna system. The active antenna system includes a printed circuit board, an antenna radiation element, a metal ground surface, M feed ports, and M control circuits. The printed circuit board has an antenna clearance region. The antenna radiation element is included in the antenna clearance region. The antenna radiation element has M physical positions. M is an integer larger than 2. The metal ground surface is formed on a first layer of the printed circuit board and outside the antenna clearance region. The M control circuits include M first terminals, M second terminals and M control terminals, respectively. The first terminals are connected to corresponding physical positions. The second terminals are connected to corresponding feed ports. The control terminals receive at least one control signal. Moreover, only one of the M control circuits is in a close state but the other control circuits are in an open state according to at least one control signal, so that the feed port and the physical position corresponding to the close-state control circuit are connected with each other but the feed ports and the physical positions corresponding to the open-state control circuits are disconnected from each other.

A further embodiment of the present invention provides a control method of an active antenna system. The active antenna system includes an antenna radiation element, a first feed port and a second feed port. Firstly, a first control signal is provided to a first control circuit, and a second control signal is provided to a second control circuit. If the first control circuit is in a close state according to the first control signal, the first feed port and a first physical position of the antenna radiation element are connected with each other, so that a signal is fed to the antenna radiation element through the first feed port and the first physical position. If the second control circuit is in the close state according to the second control signal, the second feed port and a second physical position of the antenna radiation element are connected with each other, so that the signal is fed to the antenna radiation element through the second feed port and the second physical position. Moreover, only one of the first control circuit and the second control circuit is in the close state at a time.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A (prior art) schematically illustrates the configurations of a conventional single-fed 4G passive antenna;

FIG. 1B (prior art) schematically illustrates the dimensions of a radiation element of the antenna of FIG. 1A;

FIG. 1C (prior art) schematically illustrates the relationship between the measured return loss and the frequency bandwidth of the antenna of FIG. 1A;

FIG. 2A (prior art) schematically illustrates the configurations of another conventional single-fed 4G passive antenna;

FIG. 2B (prior art) schematically illustrates the dimensions of a radiation element of the antenna of FIG. 2A;

FIG. 2C (prior art) schematically illustrates the relationship between the measured return loss and the frequency bandwidth of the antenna of FIG. 2A;

FIG. 3A (prior art) schematically illustrates the configurations of another conventional single-fed 4G passive antenna;

FIG. 3B (prior art) schematically illustrates the dimensions of a radiation element of the antenna of FIG. 3A;

FIG. 3C (prior art) schematically illustrates the relationship between the measured return loss and the frequency bandwidth of the antenna of FIG. 3A;

FIG. 4 (prior art) is a schematic functional block diagram illustrating a conventional single-fed active antenna system;

FIG. 5A schematically illustrates the configurations of a dual-fed active antenna system according to a first embodiment of the present invention;

FIGS. 5B and 5C schematically illustrate two equivalent circuits of the dual-fed active antenna system of FIG. 5A in a normal working mode;

FIG. 5D schematically illustrates the relationship between the measured return loss and the frequency bandwidth of the dual-fed active antenna system of FIG. 5A;

FIG. 6A schematically illustrates the configurations of a dual-fed active antenna system according to a second embodiment of the present invention;

FIG. 6B schematically illustrates the dimensions of a radiation element of the dual-fed active antenna system of FIG. 6A;

FIGS. 6C and 6D schematically illustrate two equivalent circuits of the dual-fed active antenna system of FIG. 6A in a normal working mode; and

FIG. 6E schematically illustrates the relationship between the measured return loss and the frequency bandwidth of the dual-fed active antenna system of FIG. 6A.

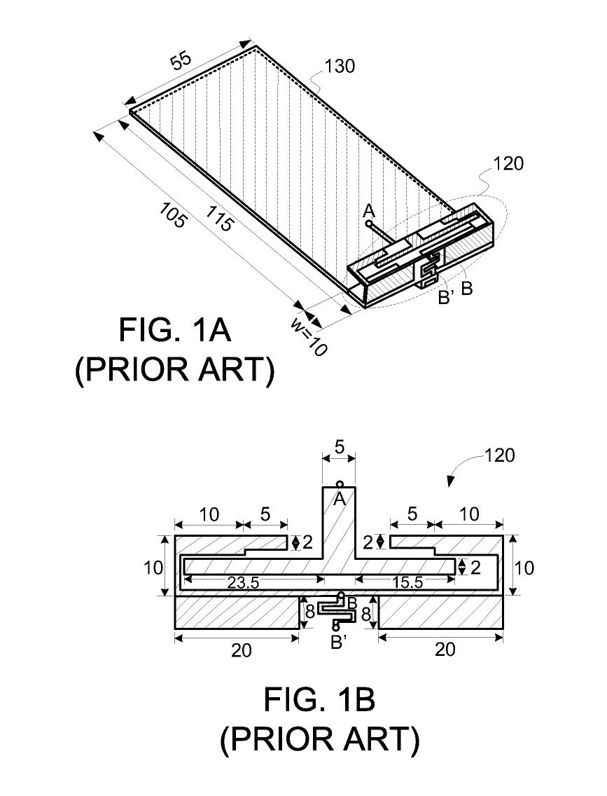

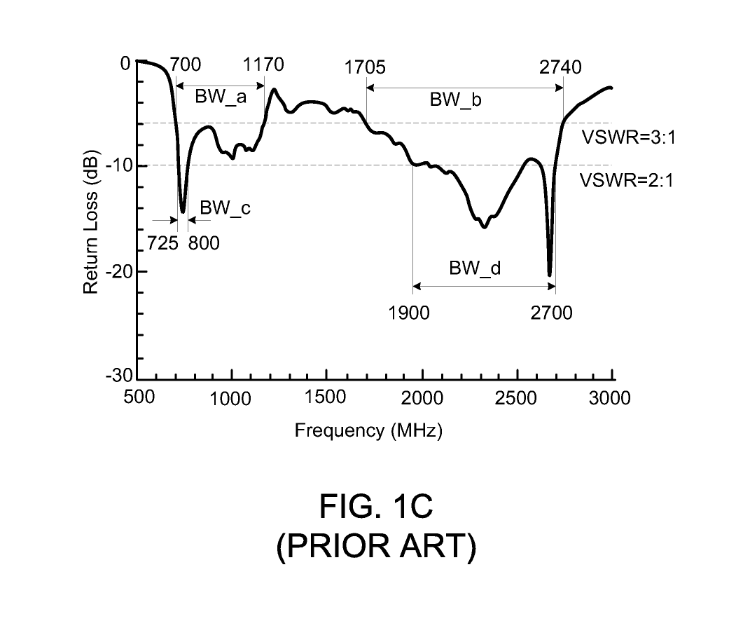

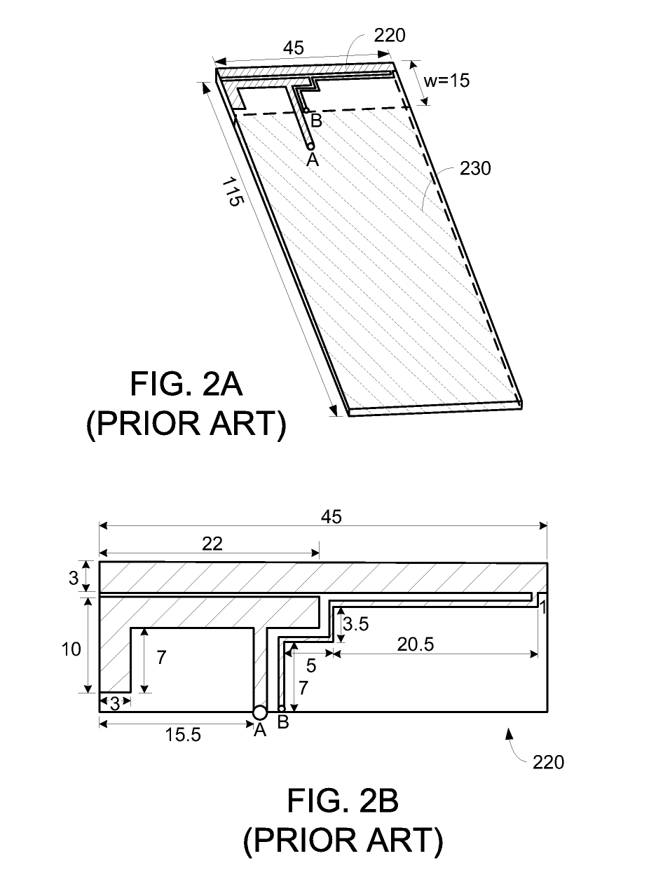

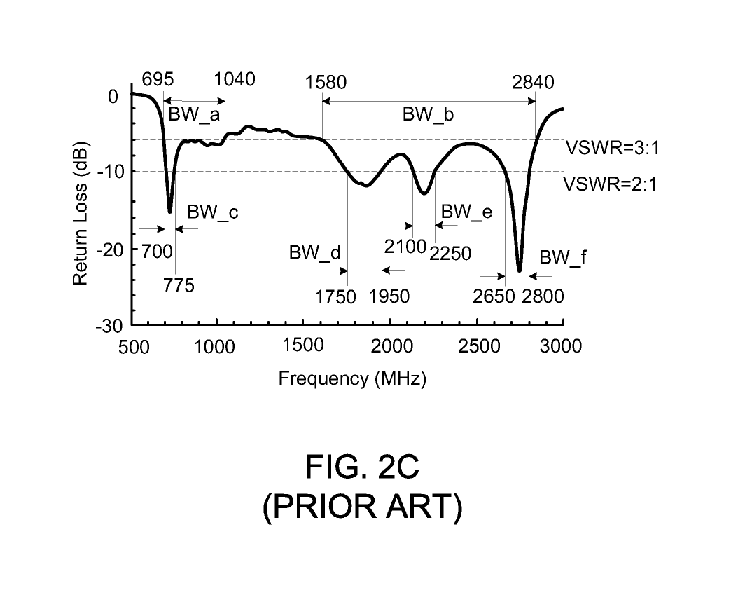

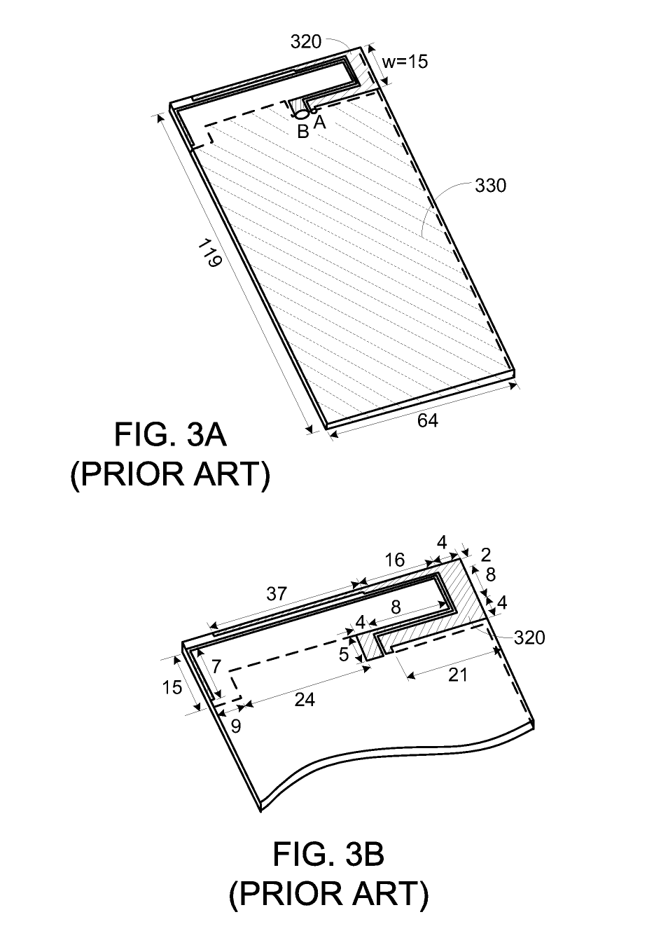

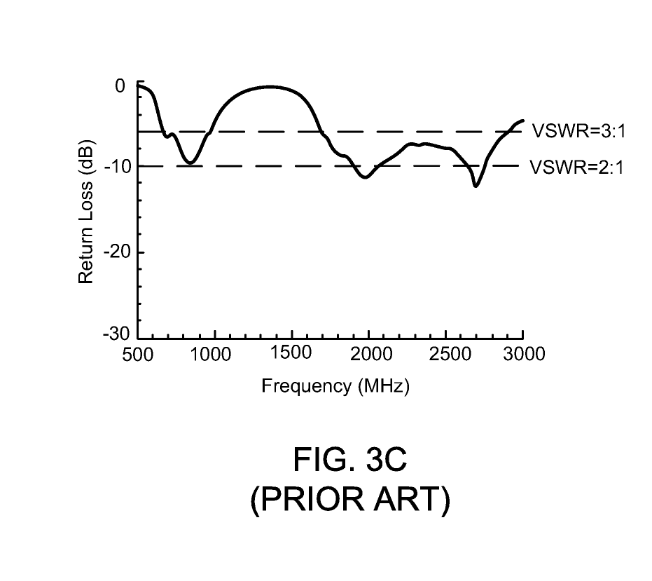

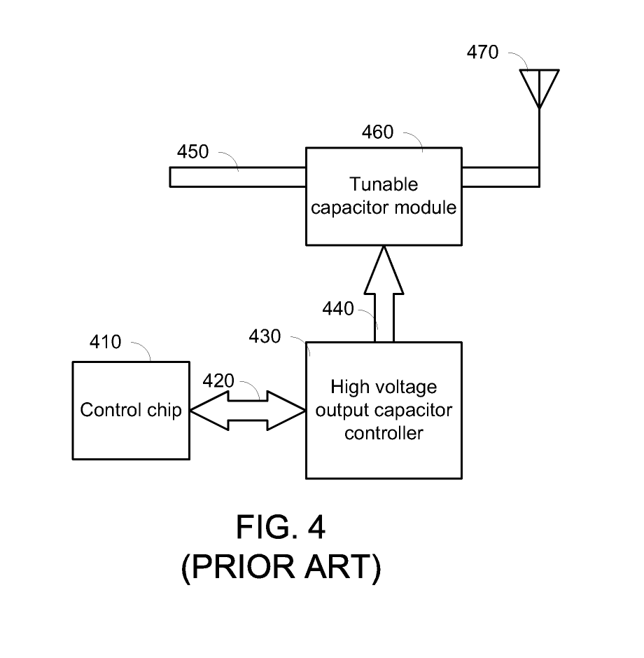

### DETAILED DESCRIPTION OF PREFERRED EMBODIMENTS

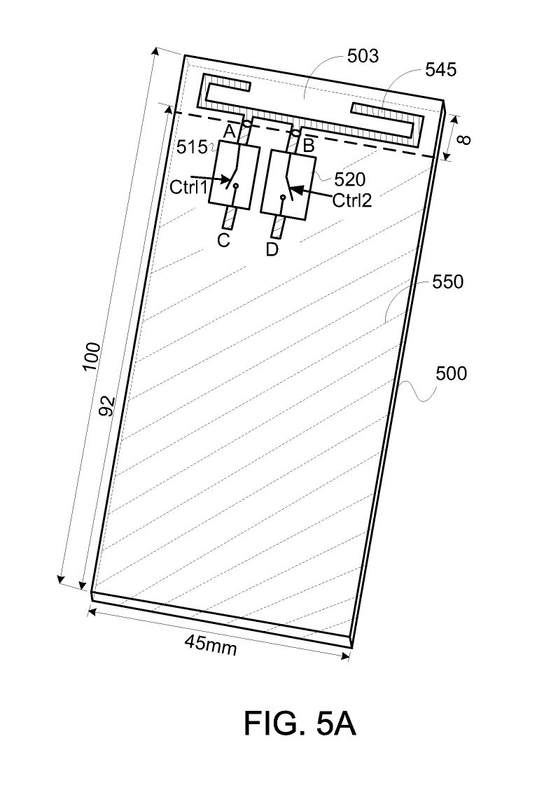

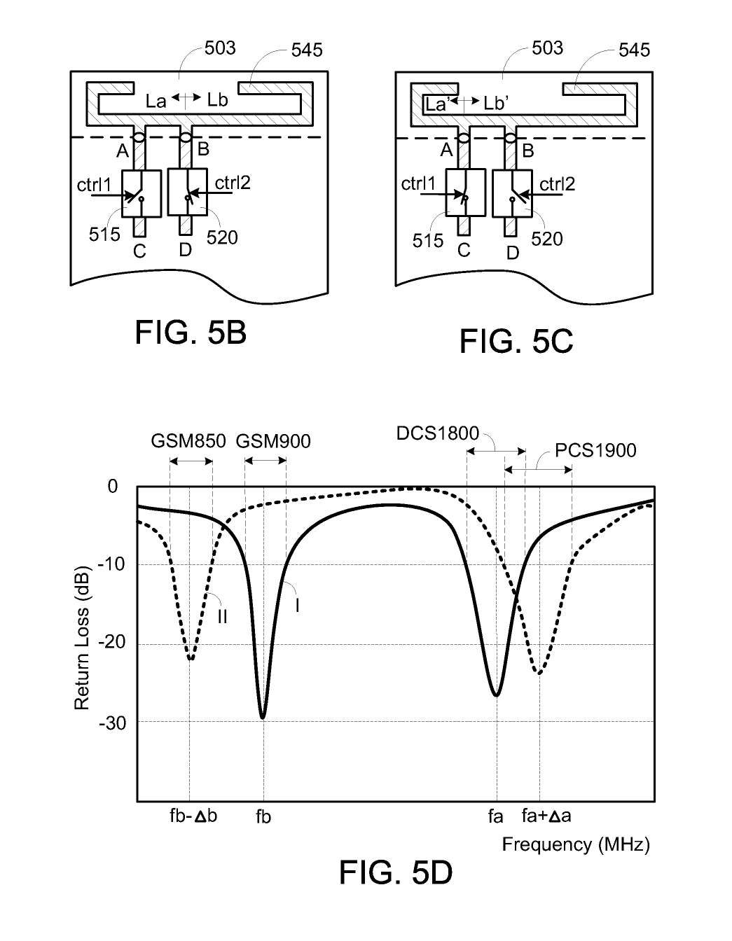

FIG. 5A schematically illustrates the configurations of a dual-fed active antenna system according to a first embodiment of the present invention. FIGS. 5B and 5C schematically illustrate two equivalent circuits of the dual-fed active antenna system of FIG. 5A in a normal working mode. FIG. 5D schematically illustrates the relationship between the measured return loss and the frequency bandwidth of the dual-fed active antenna system of FIG. 5A. The dual-fed active antenna system is formed on a printed circuit board 500. The printed circuit board 500 has a length of 100 mm and a width of 45 mm. The printed circuit board 500 has an antenna clearance region 503 with a length of 45 mm and a width of 8 mm. An antenna radiation element 545 is included in the antenna clearance region 503.

The dual-fed active antenna system further comprises a first control circuit 515 and a second control circuit 520. The first control circuit 515 and the second control circuit 520 are formed on a top layer of the printed circuit board 500 and outside the antenna clearance region 503. The antenna radiation element 545 has two different physical positions A and B. A first terminal of the first control circuit 515 is connected with the physical position A. A second terminal of the first control circuit 515 is connected with a first feed port C. Moreover, a control terminal of the first control circuit 515 receives a first control signal ctrl1, so that the first control circuit 515 is controlled by the first control signal ctrl1. A first terminal of the second control circuit 520 is connected with the physical position B. A second terminal of the second control circuit 520 is connected with a second feed port D. Moreover, a control terminal of the second control circuit 520 receives a second control signal ctrl2, so that the second control circuit 520 is controlled by the second control signal ctrl2.

Moreover, a metal ground surface 550 is formed on a bottom layer of the printed circuit board 500 and outside the antenna clearance region 503. The metal ground surface 550 has a length of 92 mm and a width of 45 mm. The first feed port C, the second feed port D, the first control circuit 515 and the second control circuit 520 are all disposed on the top layer of the printed circuit board 500, and disposed over the metal ground surface 550.

In this embodiment, the first control circuit 515 is a switch. According to the first control signal ctrl1, the first control circuit 515 is selectively in a close state or an open state. In case that the first control circuit 515 is in the open state, the physical position A and the first feed port C are not electrically connected with each other. Under this circumstance, the physical position A is in a high impedance state, and thus the signal fails to be fed into the antenna radiation element 545 through the first feed port C. Whereas, in case that the first control circuit 515 is in the close state, an electrical connection between the physical position A and the first feed port C is established. Since the physical position A and the first feed port C are electrically connected with each other, the signal can be fed into the antenna radiation element 545 through the first feed port C and the physical position A.

Similarly, the second control circuit 520 is a switch. According to the second control signal ctrl2, the second control circuit 520 is selectively in a close state or an open state. In case that the second control circuit 520 is in the open state, the physical position B and the second feed port D are not electrically connected with each other. Under this circumstance, the physical position B is in a high impedance state, and thus the signal fails to be fed into the antenna radiation element 545 through the second feed port D. Whereas, in case that the second control circuit 520 is in the close state, an electrical connection between the physical position B and the second feed port D is established. Since the physical position B and the second feed port D are electrically connected with each other, the signal can be fed into the antenna radiation element 545 through the second feed port D and the physical position B.

In the dual-fed active antenna system of the first embodiment, the antenna radiation element 545 is not connected with the metal ground surface 550. In the normal working mode, only one of the first control circuit 515 and the second control circuit 520 is in the close state.

In the normal working mode of FIG. 5B, the first control circuit 515 is in the open state, but the second control circuit 520 is in the close state. Under this circumstance, the physical position A is in a high impedance state, and thus the signal fails to be fed into the antenna radiation element 545 through the first feed port C. In addition, the signal can be fed into the antenna radiation element 545 through the second feed port D and the physical position B. The radiation path length at the left side of the physical position B of the antenna radiation element 545 is equal to La, and the radiation path length at the right side of the physical position B of the antenna radiation element 545 is equal to Lb. The solid curve I of FIG. 5D denotes the result of the measured return loss of the antenna system in the normal working mode of FIG. 5B. That is, when the signal is fed into the second feed port D, the radiation path lengths La and Lb resonate at a high resonant frequency fa and a low resonant frequency fb, respectively.

In the normal working mode of FIG. 5C, the first control circuit 515 is in the close state, but the second control circuit 520 is in the open state. Under this circumstance, the physical position B is in a high impedance state, and thus the signal fails to be fed into the antenna radiation element 545 through the second feed port D. In addition, the signal can be fed into the antenna radiation element 545 through the first feed port C and the physical position A. The radiation path length at the left side of the physical position A of the antenna radiation element 545 is equal to La′, and the radiation path length at the right side of the physical position A of the antenna radiation element 545 is equal to Lb′.

After the normal working mode of FIG. 5B is switched to the normal working mode of FIG. 5C, the radiation path length at the left side of the antenna radiation element 545 is changed from La to La′ (La′<La), and the radiation path length at the right side of the antenna radiation element 545 is changed from Lb to Lb′ (Lb′>Lb). The dotted curve II of FIG. 5D denotes the result of the measured return loss of the antenna system in the normal working mode of FIG. 5C. After the two radiation path lengths are changed and the signal is fed into the first feed port C, the radiation path lengths La′ and Lb′ resonate at a higher resonant frequency (fa+Δa) and a lower resonant frequency (fb−Δb), respectively.

From the above discussions about the first embodiment, one of the first control circuit 515 and the second control circuit 520 is in the close state according to the first control signal CtrI1 and the second control signal Ctrl2. Moreover, the antenna radiation element 545 has the two different physical positions A and B. In case that the signal is fed into the first feed port C, the result of the measured return loss of the antenna system is indicated as the dotted curve II. Consequently, the radiation path lengths La′ and Lb′ resonate at the higher resonant frequency (fa+Δa) and the lower resonant frequency (fb−Δb), respectively. Whereas, in case that the signal is fed into the second feed port D, the result of the measured return loss of the antenna system is indicated as the solid curve I. Consequently, the radiation path lengths La and Lb resonate at a high resonant frequency fa and a low resonant frequency fb, respectively. In other words, the dual-fed active antenna system can support the four frequency bands fa, (fa+Δa), fb and (fb−Δb).

Consequently, by properly adjusting the radiation path lengths La, Lb, La′ and Lb′, the bandwidth of the antenna system may cover the four frequency bands GSM850, GSM900, DCS1800 and PCS1900.

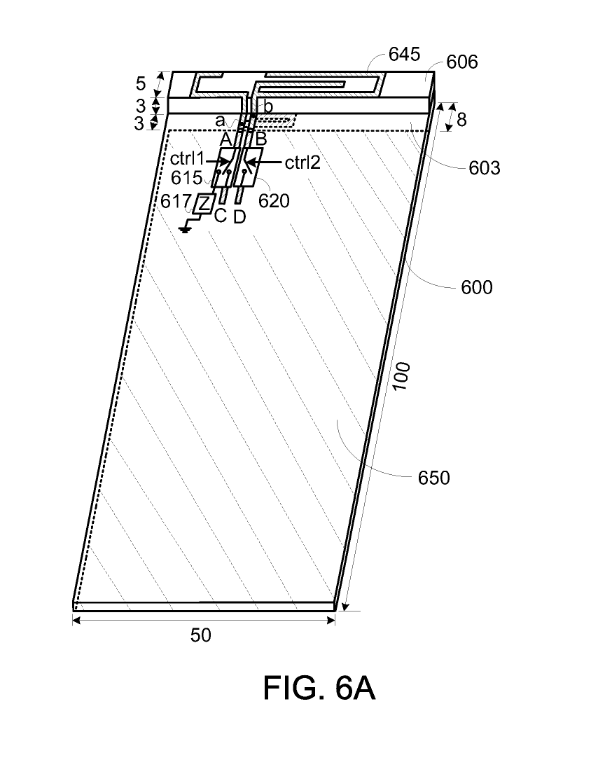

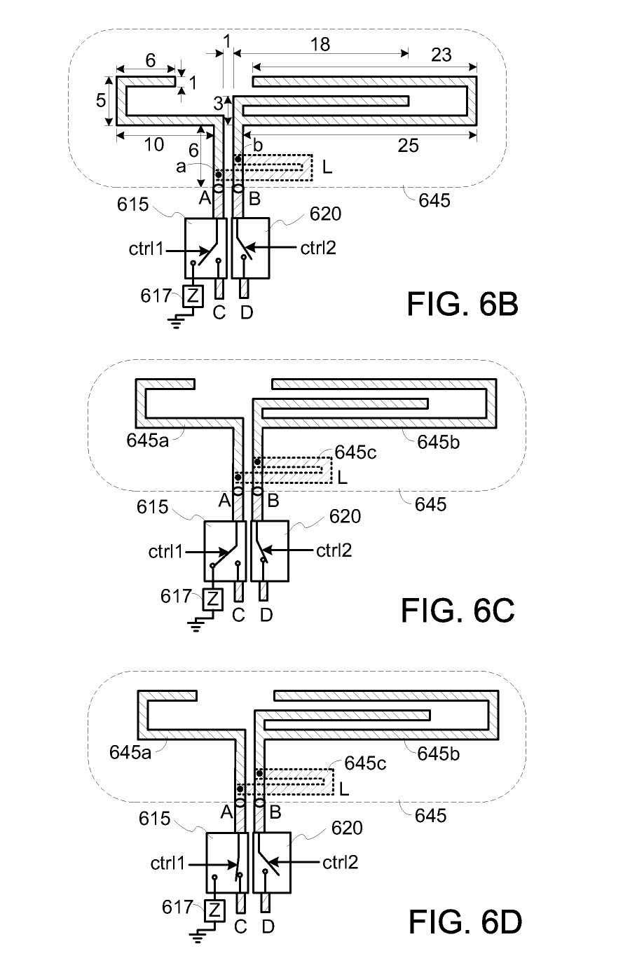

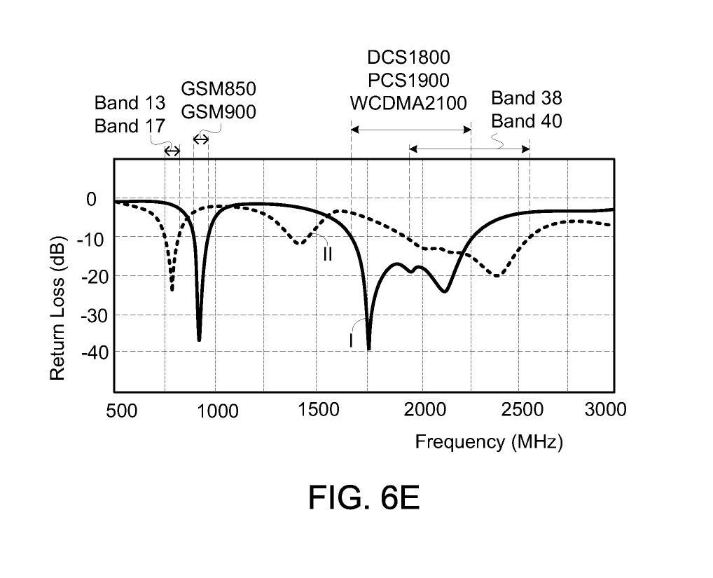

FIG. 6A schematically illustrates the configurations of a dual-fed active antenna system according to a second embodiment of the present invention. FIG. 6B schematically illustrates the dimensions of a radiation element of the dual-fed active antenna system of FIG. 6A. FIGS. 6C and 6D schematically illustrate two equivalent circuits of the dual-fed active antenna system of FIG. 6A in a normal working mode. FIG. 6E schematically illustrates the relationship between the measured return loss and the frequency bandwidth of the dual-fed active antenna system of FIG. 6A.

The dual-fed active antenna system is formed on a printed circuit board 600. The printed circuit board 600 has a length of 100 mm and a width of 50 mm. The printed circuit board 600 has an antenna clearance region 603 with a length of 50 mm and a width of 8 mm. An antenna radiation element 645 is included in the antenna clearance region 603. Moreover, a raised block 606 is further included in the antenna clearance region 603. The height, width and length of the raised block 606 are 3 mm, 5 mm and 50 mm, respectively. A portion of the antenna radiation element 645 is formed on the raised block 606.

Moreover, a metal ground surface 650 is formed on a bottom layer of the printed circuit board 600 and outside the antenna clearance region 603. The metal ground surface 650 has a length of 92 mm and a width of 50 mm. The dual-fed active antenna system further comprises a matching element 617, a first control circuit 615 and a second control circuit 620. The matching element 617, the first control circuit 615 and the second control circuit 620 are formed on a top layer of the printed circuit board 600 and outside the antenna clearance region 603. The matching element 617, the first feed port C, the second feed port D, the first control circuit 615 and the second control circuit 620 are all disposed on the top layer of the printed circuit board 600, and disposed over the metal ground surface 650. An end of the matching element 617 is connected to the metal ground surface 650 through a via (not shown).

As shown in FIG. 6B, the antenna radiation element 645 has two different physical positions A and B. Moreover, the antenna radiation element 645 comprises a first branch 645a, a second branch 645b and a linking branch 645c (see FIGS. 6C and 6D). The linking branch 645c is shown in dotted lines. The physical position A is located at the first branch 645a. The physical position B is located at the second branch 645b. The length L of the linking branch 645c is in the range between 10 mm and 40 mm.

In this embodiment, the linking branch 645c is formed on the bottom layer of the printed circuit board 600 and included in the antenna clearance region 603. The first branch 645a and the second branch 645b are formed on the antenna clearance region 603 of the top layer of the printed circuit board 600 and the raised block 606. Moreover, the first branch 645a is connected with a first terminal of the linking branch 645c through a first via “a”, and the second branch 645b is connected with a second terminal of the linking branch 645c through a second via “b”.

A first terminal of the first control circuit 615 is connected with the physical position A. A second terminal of the first control circuit 615 is connected with the first feed port C. A third terminal of the first control circuit 615 is connected with the metal ground surface 650 through the matching element 617. Moreover, a control terminal of the first control circuit 615 receives a first control signal ctrl1, so that the first control circuit 615 is controlled by the first control signal ctrl1. A first terminal of the second control circuit 620 is connected with the physical position B. A second terminal of the second control circuit 620 is connected with the second feed port D. Moreover, a control terminal of the second control circuit 620 receives a second control signal ctrl2, so that the second control circuit 620 is controlled by the second control signal ctrl2.

In this embodiment, the first control circuit 615 is a single-pole-double-throw (SPDT) switch. According to the first control signal ctrl1, the first control circuit 615 is selectively in a close state or a matching state. In case that the first control circuit 615 is in the close state, an electrical connection between the physical position A and the first feed port C is established. Since the physical position A and the first feed port C are electrically connected with each other, the signal can be fed into the antenna radiation element 645 through the first feed port C and the physical position A. Whereas, in case that the first control circuit 615 is in the matching state, the physical position A and the first feed port C are not electrically connected with each other. Under this circumstance, the signal fails to be fed into the antenna radiation element 645 through the first feed port C. That is, in the matching state, the physical position A is connected with the metal ground surface 650 through the matching element 617. In this embodiment, the impedance value Z of the matching element 617 is zero. When the first control circuit 615 is in the matching state, the antenna radiation element 645 is connected to ground through the physical position A. Under this circumstance, the physical position A is in a low impedance state (or a specified impedance state). It is noted that the impedance value Z of the matching element 617 is not restricted. The impedance value Z of the matching element 617 may be determined according to the practical requirements. Preferably, the impedance value Z is set as a specified impedance value.

In this embodiment, the second control circuit 620 is a switch. According to the second control signal ctrl2, the second control circuit 620 is selectively in a close state or an open state. In case that the second control circuit 620 is in the open state, the physical position B and the second feed port D are not electrically connected with each other. Under this circumstance, the physical position B is in a high impedance state, and thus the signal fails to be fed into the antenna radiation element 645 through the second feed port D. Whereas, in case that the second control circuit 620 is in the close state, an electrical connection between the physical position B and the second feed port D is established. Since the physical position B and the second feed port D are electrically connected with each other, the signal can be fed into the antenna radiation element 645 through the second feed port D and the physical position B.

In the dual-fed active antenna system of the second embodiment, the antenna radiation element 645 is not connected with the metal ground surface 650. In the normal working mode, only one of the first control circuit 615 and the second control circuit 620 is in the close state and connected with the antenna radiation element 645 through the corresponding feed port. In case that the first control circuit 615 is in the close state but the second control circuit 620 is in the open state, the signal can be fed into the antenna radiation element 545 through the first feed port C and the physical position A. Whereas, in case that the first control circuit 615 is in the matching state but the second control circuit 620 is in the close state, the signal can be fed into the antenna radiation element 645 through the second feed port D and the physical position B. The operating principles will be illustrated as follows in more details.

In the normal working mode of FIG. 6C, the first control circuit 615 is in the matching state, but the second control circuit 620 is in the close state. Under this circumstance, the signal fails to be fed into the antenna radiation element 645 through the first feed port C. Since the impedance value Z of the matching element 617 is zero, the antenna radiation element 645 is connected to ground through the physical position A and the physical position A is in the low impedance state. Meanwhile, the signal can be fed into the antenna radiation element 645 through the second feed port D and the physical position B. The solid curve I of FIG. 6E denotes the result of the measured return loss of the antenna system in the normal working mode of FIG. 6C. The bandwidth of the antenna system covers the low frequency bands GSM850 and GSM900 and the high frequency bands DCS1800, PCS1900 and WCDMA2100.

In the normal working mode of FIG. 6D, the first control circuit 615 is in the close state, but the second control circuit 620 is in the open state. Under this circumstance, the physical position B is in a high impedance state, and thus the signal fails to be fed into the antenna radiation element 545 through the second feed port D. In addition, the signal can be fed into the antenna radiation element 645 through the first feed port C and the physical position A.

After the normal working mode of FIG. 6C is switched to the normal working mode of FIG. 6D, the radiation path length at the left side of the antenna radiation element 645 resonates at a higher resonant frequency, and the bandwidth of the antenna system covers the 2300-2620 MHz 4G frequency band (i.e. Band 38 and Band 40 in China). The radiation path length at the right side of the antenna radiation element 645 contains the linking branch 645c and resonates at a lower resonant frequency. By properly adjusting the length L of the linking branch 645c, the bandwidth of the antenna system covers the 700 MHz frequency band (Band 13 and Band 17 in USA). The dotted curve II of FIG. 6E denotes the result of the measured return loss of the antenna system in the normal working mode of FIG. 6D.

From the above discussions about the second embodiment, one of the first control circuit 615 and the second control circuit 620 is in the close state according to the first control signal Ctrl1 and the second control signal Ctrl2. Moreover, the antenna radiation element 645 has the two different physical positions A and B. In case that the signal is fed into the first feed port C, the result of the measured return loss of the antenna system is indicated as the dotted curve II. Consequently, the bandwidth of the antenna system covers the 700 MHz frequency band and 2300˜2620 MHz frequency band according to the 4G mobile communication standards. Whereas, in case that the signal is fed into the second feed port D, the result of the measured return loss of the antenna system is indicated as the solid curve I. Consequently, the bandwidth of the antenna system may cover the four frequency bands GSM850, GSM900, DCS1800, PCS1900 and WCDMA2100.

In the above two embodiments, the printed circuit board is a two-layered printed circuit board comprising a top layer and a bottom layer. It is noted that the printed circuit board may comprise more than two layers. For example, in case that the printed circuit board comprises four layers, the metal ground surface may be formed on the bottom layer or any other appropriate layer. For example, the metal ground surface may be formed on any inner layer between the top layer and the bottom layer of the printed circuit board. That is, the metal ground surface and the control circuits are disposed on different layers of the printed circuit board. Alternatively, in some other embodiments, the matching element 617, the first control circuit and the first feed port are formed on the top layer of the printed circuit board, the second control circuit and the second feed port are formed on the bottom layer of the printed circuit board, and the metal ground surface is formed on the inner layer of the printed circuit board.

In the above two embodiments, the first control circuit and the second control circuit are controlled according to the first control signal Ctrl1 and the second control signal Ctrl2, respectively. It is noted that both of the first control circuit and the second control circuit may be controlled according to a single control signal. For example, if the dual-fed active antenna system has the configurations as shown in FIG. 5A, the first control circuit 515 is in the open state but the second control circuit 520 is in the close state when the control signal has a first voltage level, and the first control circuit 515 is in the close state but the second control circuit 520 is in the open state when the control signal has a second voltage level. Consequently, both of the first control circuit 515 and the second control circuit 520 are controlled according to the single control signal.

In the above two embodiments, the first control circuit and the second control circuit are implemented by switches. However, those skilled in the art will readily observe that the first control circuit and the second control circuit may be implemented by other appropriate comparable devices. For example, in case that the first control circuit and the second control circuit are diodes, the control circuits are in the close state when the diodes are forwardly biased according to the control signal, and the control circuits are in the open state when the diodes are reversely biased according to the control signal.

In the above two embodiments, the antenna system comprises two feed ports and two control circuits. However, those skilled in the art will readily observe that the active antenna system may comprise more than two feed ports (e.g. M feed ports), plural control circuits (e.g. M control circuits) and plural physical positions (e.g. M physical positions) in order to achieve more frequency bands. During operations of the active antenna system, only one of the control circuits is in the close state, but the other control circuits are in the open state. That is, the other (M−1) physical positions and the other (M−1) feed ports are disconnected from each other.

From the above descriptions, the present invention provides an active antenna system. The active antenna system can be easily fabricated. Moreover, since the control signal is very simple, the complexity of designing and controlling the active antenna system is largely reduced. Moreover, since multiple feed ports are connected with different physical positions of the antenna radiation element, signals may be fed to the antenna radiation element through different feed ports. In such way, different frequency bands are achieved. Moreover, by adjusting the impedance states of other physical positions through the control circuits, the active antenna system may be operated in more resonant modes and the antenna bandwidth may cover more frequency bands. Moreover, the antenna size of the active antenna system is reduced.

Moreover, the verification results of the second embodiment indicate that the antenna bandwidth of the fourth generation mobile antenna can cover all of the 2G/3G/4G frequency bands while achieving good impedance matching efficacy. Moreover, the complexity of designing the active antenna system is largely reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An active antenna system with multiple feed ports, the active antenna system comprising:
a printed circuit board having an antenna clearance region;
an antenna radiation element included in the antenna clearance region, wherein the antenna radiation element has a first physical position and a second physical position;
a metal ground surface formed on a first layer of the printed circuit board and outside the antenna clearance region;
a first control circuit, wherein a first terminal of the first control circuit is connected to the first physical position, a second terminal of the first control circuit is connected to a first feed port, and a control terminal of the first control circuit receives a first control signal, wherein the first feed port and the first physical position are selectively connected with each other or disconnected from each other according to the first control signal; and
a second control circuit, wherein a first terminal of the second control circuit is connected to the second physical position, a second terminal of the second control circuit is connected to a second feed port, and a control terminal of the second control circuit receives a second control signal, wherein the second feed port and the second physical position are selectively connected with each other or disconnected from each other according to the second control signal,
wherein the first control circuit and the first feed port are formed on a second layer of the printed circuit board and outside the antenna clearance region.

2. The active antenna system as claimed in claim 1, wherein the second control circuit and the second feed port are formed on the second layer of the printed circuit board and outside the antenna clearance region, and the first feed port, the second feed port, the first control circuit and the second control circuit are disposed over the metal ground surface.

3. The active antenna system as claimed in claim 1, wherein if the first physical position and the first feed port are disconnected from each other but the physical position is connected with the a matching element, the first physical position is in a specified impedance state.

4. The active antenna system as claimed in claim 1, wherein if the second physical position and the second feed port are disconnected from each other, the second physical position is in a high impedance state.

5. The active antenna system as claimed in claim 1, wherein when the second physical position and the second feed port are disconnected from each other, the first physical position and the first feed port are connected with each other, and wherein when the second physical position and the second feed port are connected with each other, the first physical position and the first feed port are disconnected from each other.

6. The active antenna system as claimed in claim 1, wherein the antenna radiation element comprises:
a first branch, wherein the first physical position is located at the first branch;
a second branch, wherein the second physical position is located at the second branch; and
a linking branch connected with the first branch and the second branch.

7. The active antenna system as claimed in claim 1, wherein the active antenna system further comprises a raised block, and the raised block is included in the antenna clearance region, wherein a portion of the antenna radiation element is formed on the raised block.

8. An active antenna system, comprising:
a printed circuit board having an antenna clearance region;
an antenna radiation element included in the antenna clearance region, wherein the antenna radiation element has M physical positions, wherein M is an integer larger than 2;
a metal ground surface formed on a first layer of the printed circuit board and outside the antenna clearance region;
M feed ports; and
M control circuits comprising M first terminals, M second terminals and M control terminals, respectively, wherein the first terminals are connected to corresponding physical positions, the second terminals are connected to corresponding feed ports, and the control terminals receive at least one control signal, wherein only one of the M control circuits is in a close state but the other control circuits are in an open state according to at least one control signal, so that the feed port and the physical position corresponding to the close-state control circuit are connected with each other but the feed ports and the physical positions corresponding to the open-state control circuits are disconnected from each other.

9. The active antenna system as claimed in claim 8, wherein the M control circuits and the M feed ports are formed on a second layer of the printed circuit board and outside the antenna clearance region, and the M control circuits and the M feed ports are disposed over the metal ground surface.

10. The active antenna system as claimed in claim 8, wherein if the feed ports and the physical positions corresponding to the open-state control circuits are disconnected from each other, the physical positions corresponding to the open-state control circuits are in a specified impedance state.

11. The active antenna system as claimed in claim 8, wherein the active antenna system further comprises a raised block, and the raised block is included in the antenna clearance region, wherein a portion of the antenna radiation element is formed on the raised block.

12. A control method of an active antenna system, the active antenna system comprising an antenna radiation element, a first feed port and a second feed port, the control method comprising steps of:
providing a first control signal to a first control circuit and providing a second control signal to a second control circuit;
if the first control circuit is in a close state according to the first control signal, the first feed port and a first physical position of the antenna radiation element are connected with each other, so that a signal is fed to the antenna radiation element through the first feed port and the first physical position; and
if the second control circuit is in the close state according to the second control signal, the second feed port and a second physical position of the antenna radiation element are connected with each other, so that the signal is fed to the antenna radiation element through the second feed port and the second physical position,
wherein only one of the first control circuit and the second control circuit is in the close state at a time.

13. The control method as claimed in claim 12, wherein the antenna radiation element is included in an antenna clearance region of a printed circuit board, a metal ground surface is formed on a first layer of the printed circuit board and outside the antenna clearance region, and the first control circuit and the first feed port are formed on a second layer of the printed circuit board and outside the antenna clearance region.
